(19) United States
(12) Patent Application Publication
(10) Pub. No.: US 2026/0307579 A1
(43) Pub. Date: Oct. 8, 2026

(54) Mattress Strap

(71) Applicant: Hanniver Innovation, LLC, Pittsburgh, PA (US)

(72) Inventor: Ryan T. Brooks, Pittsburgh, PA (US)

(21) Appl. No.: 19/637,118

(22) Filed: Apr. 2, 2026

Related U.S. Application Data
(60) Provisional application No. 63/782,223, filed on Apr. 2, 2025.

(51) Int. Cl. B60P 7/08; A47C 31/00

(52) U.S. Cl. CPC B60P 7/0823; A47C 31/00

(57) ABSTRACT

Provided is a mattress securing system for use with a motor vehicle. The mattress securing system may include a plurality of straps configured to secure a mattress to a roof of the motor vehicle, the plurality of straps may include a lattice strap, at least one longitudinal strap, and at least one lateral strap, one or more adjustable fasteners connected to each strap of the plurality of straps, the adjustable fasteners configured to allow a user to tighten each strap of the plurality of straps, and at least one attachment feature configured to secure the plurality of straps to one or more structural components of the motor vehicle.

### CROSS REFERENCE TO RELATED APPLICATION

This application claims the benefit of U.S. Provisional Patent Application No. 63/782,223, filed Apr. 2, 2025, the disclosure of which is hereby incorporated by reference in its entirety.

### BACKGROUND

### Field of the Invention

This invention relates generally to transportation and securing systems, and more particularly, to an adjustable securing apparatus for attaching and stabilizing mattresses, box springs, or similarly shaped rectangular objects onto the roof of most passenger vehicles.

### Description of Related Art

Transporting large or cumbersome items such as mattresses or box springs on the roofs of vehicles is a common yet challenging task. Current methods generally involve ropes, ratchet straps, or improvised materials, which may lead to insufficient securing and unsafe transportation practices. Existing ratchet straps and rope systems frequently require complicated tying methods or extensive manual tightening, leading to inconsistent tension, difficulty of use, and potential damage to the cargo or vehicle.

Various specialized racks or securing devices have been designed but are often limited to particular vehicle models, or require permanently mounted hardware that reduces versatility and increases installation complexity. Additionally, few existing solutions conveniently accommodate stacking multiple large rectangular items securely atop one another.

Therefore, there remains a clear need in the art for a universal, vehicle-compatible securing system specifically designed to quickly, effectively, and safely attach mattresses, box springs, or similar bulky rectangular items to passenger vehicles, while offering adjustable tension, ease of use, flexibility of attachment points, and the capability to secure multiple items simultaneously.

### SUMMARY

The invention is summarized below only for purposes of introducing embodiments of the invention. The ultimate scope of the invention is to be limited only to the claims that follow the specification.

Accordingly, provided is a mattress strap including a plurality of straps and a series of fasteners configured to secure the plurality of straps together and to tighten and secure a mattress and/or a box spring to the top of a motor vehicle.

According to some non-limiting embodiments or aspects, provided is a mattress securing system for use with a motor vehicle. The mattress securing system may include a plurality of straps configured to secure a mattress to a roof of the motor vehicle, the plurality of straps may include a lattice strap, at least one longitudinal strap, and at least one lateral strap, one or more adjustable fasteners connected to each strap of the plurality of straps, the adjustable fasteners configured to allow a user to tighten each strap of the plurality of straps, and at least one attachment feature configured to secure the plurality of straps to one or more structural components of the motor vehicle.

In some non-limiting embodiments or aspects, the lattice strap may be configured to extend around at least a portion of a top side of the mattress and at least a portion of a bottom side of the mattress.

In some non-limiting embodiments or aspects, the lattice strap may extend around at least a portion of a front side of the mattress and at least a portion of a rear side of the mattress.

In some non-limiting embodiments or aspects, the lattice strap may extend around at least a portion of a first lateral side of the mattress and at least a portion of a second lateral side of the mattress.

In some non-limiting embodiments or aspects, the lattice strap may define a generally rectangular perimeter sized and shaped to receive the mattress therein.

In some non-limiting embodiments or aspects, the lattice strap may be adjustable to accommodate mattresses of different sizes.

In some non-limiting embodiments or aspects, the at least one longitudinal strap may extend along a longitudinal direction of the mattress to inhibit forward and rearward movement of the mattress relative to the motor vehicle.

In some non-limiting embodiments or aspects, the at least one longitudinal strap may extend over a top side of the mattress, around a front side of the mattress, around a rear side of the mattress, and beneath a bottom side of the mattress.

In some non-limiting embodiments or aspects, the at least one lateral strap may extend along a lateral direction of the mattress to inhibit side-to-side movement of the mattress relative to the motor vehicle.

In some non-limiting embodiments or aspects, the at least one lateral strap may extend over a top side of the mattress, around at least a portion of a first lateral side of the mattress, and around at least a portion of a second lateral side of the mattress.

In some non-limiting embodiments or aspects, the at least one longitudinal strap and the at least one lateral strap may be removably attachable to the lattice strap via the one or more adjustable fasteners.

In some non-limiting embodiments or aspects, the at least one attachment feature may include one or more strap loops configured to engage one or more of a side-view mirror, a window opening, a trunk opening, or a hatch opening of the motor vehicle.

In some non-limiting embodiments or aspects, at least one strap loop may be received through an open window of the motor vehicle and retained by closing the window on the at least one strap loop.

In some non-limiting embodiments or aspects, at least one strap loop may be positioned within a trunk opening or hatch opening and retained by closing a trunk lid or hatch door on the at least one strap loop.

In some non-limiting embodiments or aspects, each strap of the plurality of straps comprises a fabric material.

In some non-limiting embodiments or aspects, the fabric material comprises nylon webbing, polyester webbing, polypropylene webbing, or a combination thereof.

In some non-limiting embodiments or aspects, the plurality of straps may secure a plurality of mattresses stacked relative to one another on the roof of the motor vehicle.

In some non-limiting embodiments or aspects, the lattice strap may secure a first mattress relative to the roof of the motor vehicle, and the at least one longitudinal strap and the at least one lateral strap may secure a second mattress positioned over the first mattress.

According to some non-limiting embodiments or aspects, provided is a mattress securing system for use with a motor vehicle. The mattress securing system may include a lattice strap defining a generally rectangular receiving structure sized to receive a mattress therein, the lattice strap configured to extend over a top portion of the mattress and around front, rear, bottom, and lateral side portions of the mattress, a pair of longitudinal straps removably attachable to the lattice strap and configured to extend over the top portion of the mattress, around the front and rear portions of the mattress, and beneath the bottom portion of the mattress, a pair of lateral straps removably attachable to the lattice strap and configured to extend over the top portion of the mattress and around opposing lateral side portions of the mattress, a plurality of adjustable fasteners coupled to the lattice strap, the pair of longitudinal straps, and the pair of lateral straps, the adjustable fasteners configured to permit selective tightening or loosening thereof by a user, and a plurality of attachment features coupled to the lattice strap and configured to engage one or more structural components of the motor vehicle to secure the mattress on a roof of the motor vehicle.

According to some non-limiting embodiments or aspects, provided is a method of securing a mattress to a motor vehicle. The method may include the steps of positioning a mattress on a roof of the motor vehicle, placing a lattice strap over the mattress such that the mattress is received within the lattice strap, securing the lattice strap to one or more structural components of the motor vehicle via one or more attachment features of the lattice strap, positioning at least one longitudinal strap and at least one lateral strap relative to the mattress such that the at least one longitudinal strap and the at least one lateral strap extend about at least a portion of the mattress, and tightening one or more adjustable fasteners associated with the lattice strap, the at least one longitudinal strap, and the at least one lateral strap to secure the mattress relative to the motor vehicle.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a perspective view of a mattress strap according to some non-limiting embodiments or aspects;

FIG. 2 is a perspective view of a mattress strap and mattress assembly according to some non-limiting embodiments or aspects;

FIG. 3 is a perspective view of a mattress strap and mattress assembly according to some non-limiting embodiments or aspects;

FIG. 4 is a perspective view of a mattress strap and mattress assembly according to some non-limiting embodiments or aspects; and

FIG. 5 is a perspective view of a mattress strap and mattress assembly according to some non-limiting embodiments or aspects.

### DESCRIPTION OF THE INVENTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume various alternative variations and step sequences, except where expressly specified to the contrary. It is also to be understood that the specific devices and processes illustrated in the attached drawings, and described in the following specification, are simply exemplary embodiments or aspects of the disclosure. Hence, specific dimensions and other physical characteristics related to the embodiments or aspects of the embodiments disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” As used in the specification and the claims, the singular form of “a,” “an,” and “the” include plural referents, such as unless the context clearly dictates otherwise. Additionally, as used herein, the terms “set” and “group” are intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. Further, the phrase “based on” is intended to mean “based at least partially on” unless explicitly stated otherwise.

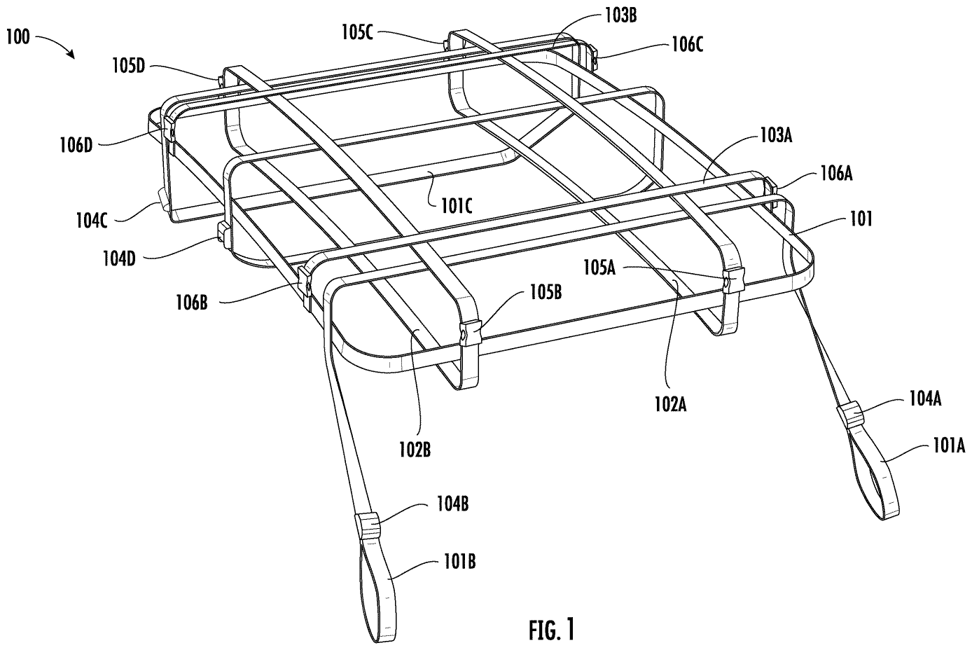

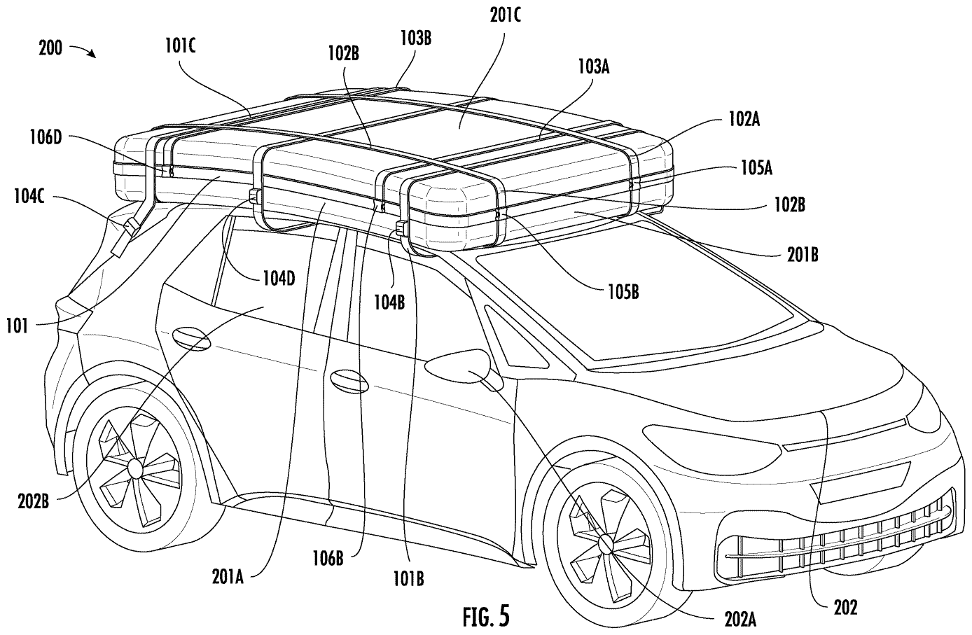

Referring now to FIG. 1, shown is a mattress strap 100 configured to secure one or more mattresses and/or box springs, according to some non-limiting embodiments or aspects. Mattress strap 100 may include a plurality of straps, each formed from a fabric material, such as nylon webbing, high-strength polyester webbing, polypropylene webbing and/or the like. In some non-limiting embodiments or aspects, mattress strap 100 may include a lattice strap 101 configured to secure a mattress and/or box spring to a motor vehicle. Lattice strap 101 may have a generally rectangular shape configured to receive and surround a mattress and/or a box spring. For example, a mattress or box spring may be placed on top of a motor vehicle, and lattice strap 101 may be positioned over the mattress such that the mattress is received within lattice strap 101. Once positioned within lattice strap 101, the mattress may be secured relative to the motor vehicle via at least one attachment feature. In some non-limiting embodiments or aspects, the at least one attachment feature may include strap loops 101A and 101B, which may be coupled to the left and right side-view mirrors of the motor vehicle. Additionally or alternatively, strap loops 101A and 101B may be inserted through one or more windows and/or doors of the motor vehicle, such as front and/or rear windows or doors, to secure the mattress (as shown in FIG. 5, described in further detail below). For example, after the mattress is positioned within lattice strap 101, a user may open one or more front windows, pass strap loops 101A and 101B through the windows, and pull strap loops 101A and 101B from within the vehicle so as to tension lattice strap 101 and urge the mattress downward toward the motor vehicle. The user may then close the windows on strap loops 101A and 101B to maintain the strap loops in a tensioned state and thereby retain the mattress in a secured position.

In some non-limiting embodiments or aspects, lattice strap 101 may be positioned over the mattress and secured to a rear portion of the motor vehicle, such as a trunk or hatchback, via an additional attachment feature, strap loop 101C. For example, after the mattress is positioned within lattice strap 101, the user may extend strap loop 101C beneath an open trunk lid or hatch door of the motor vehicle and then close the trunk lid or hatch door such that strap loop 101C is secured therebetween. In some non-limiting embodiments or aspects, lattice strap 101 may additionally or alternatively secure the mattress to the motor vehicle by extending a portion of lattice strap 101 through one or more rear windows of the motor vehicle. For example, similar to strap loops 101A and 101B, a portion of lattice strap 101 may extend through the rear windows and be tensioned to assist in securing the mattress relative to the motor vehicle.

In some non-limiting embodiments or aspects, lattice strap 101 may include one or more fasteners 104A-104D configured to permit a user to manually tighten lattice strap 101 so as to more securely retain the mattress against the motor vehicle. For example, lattice strap 101 may include one or more buckles, clips, and/or other adjustable fastening elements that may be manipulated by the user to tighten lattice strap 101 and thereby enhance stability of the mattress on the motor vehicle. The one or more fasteners 104A-104D may also permit lattice strap 101 to accommodate mattresses and/or box springs of varying sizes. For example, a user may first loosen fasteners 104A-104D to enlarge lattice strap 101 such that a mattress may be positioned therein, and may thereafter tighten fasteners 104A-104D to secure lattice strap 101 about the mattress. Once the mattress is secured within lattice strap 101, the mattress and lattice strap 101 may be secured to the motor vehicle via strap loops 101A-101C.

With continued reference to FIG. 1, mattress strap 100 may include a plurality of longitudinal straps 102A and 102B. In some non-limiting embodiments or aspects, longitudinal straps 102A and 102B may prevent the mattress from shifting in the longitudinal direction (e.g., frontward or rearward relative to the motor vehicle). For example, the mattress may be placed on top of the motor vehicle, under lattice strap 101 and may be further secured by longitudinal straps 102A and 102B. In some non-limiting embodiments or aspects, longitudinal straps 102A and 102B may secure the mattress from the front of the vehicle to the rear of the vehicle, thereby reducing or preventing forward and rearward movement during transit. For example, longitudinal straps 102A and 102B may loop over the top, the front, and the rear portions of the mattress and underneath both the bottom portion of the mattress and attach (e.g., via fasteners) to lattice strap 101. In some non-limiting embodiments or aspects, longitudinal straps 102A and 102B may include one or more fasteners 105A-105D to allow a user to manually tighten longitudinal straps 102A and 102B. For example, longitudinal straps 102A and 102B may include one or more buckles and/or clips that can be adjusted by the user, allowing the user to easily tighten longitudinal straps 102A and 102B to enhance stability of the mattress on top of the vehicle.

In some non-limiting embodiments or aspects, longitudinal straps 102A and 102B may be removably attachable to lattice strap 101 via fasteners 105A-105D. For example, longitudinal straps 102A and 102B may be selectively coupled to lattice strap 101 at one or more attachment locations by engaging fasteners 105A-105D. In this manner, a user may attach longitudinal straps 102A and 102B when additional longitudinal retention is desired, such as for multiple mattresses, higher-speed travel, or other transport conditions in which additional stabilization may be beneficial. Conversely, when longitudinal straps 102A and 102B are not needed, the user may detach longitudinal straps 102A and 102B from lattice strap 101 by disengaging fasteners 105A-105D.

With continued reference to FIG. 1, mattress strap 100 may include a plurality of lateral straps 103A and 103B. In some non-limiting embodiments or aspects, lateral straps 103A and 103B may prevent the mattress from shifting in the lateral direction (e.g., leftward or rightward relative to the motor vehicle). For example, the mattress may be placed on top of the motor vehicle, under lattice strap 101 and may be further secured by lateral straps 103A and 103B. In some non-limiting embodiments or aspects, lateral straps 103A and 103B may secure the mattress from the left side of the vehicle to the right side of the vehicle, thereby reducing or preventing leftward and rightward movement during transit. For example, lateral straps 103A and 103B may loop over the top, the left side, and the right-side portions of the mattress and attach (e.g., via fasteners) to lattice strap 101. In some non-limiting embodiments or aspects, lateral straps 103A and 103B may include one or more fasteners 106A-106D to allow a user to manually tighten lateral straps 103A and 103B. For example, lateral straps 103A and 103B may include one or more buckles and/or clips that can be adjusted by the user, allowing the user to easily tighten lateral straps 103A and 103B to enhance stability of the mattress on top of the vehicle.

In some non-limiting embodiments or aspects, lateral straps 103A and 103B may be removably attachable to lattice strap 101 via fasteners 106A-106D. For example, lateral straps 103A and 103B may be selectively coupled to lattice strap 101 at one or more attachment locations by engaging fasteners 106A-106D. In this manner, a user may attach lateral straps 103A and 103B when additional lateral retention is desired, such as for multiple mattresses, higher-speed travel, or other transport conditions in which additional stabilization may be beneficial. Conversely, when lateral straps 103A and 103B are not needed, the user may detach lateral straps 103A and 103B from lattice strap 101 by disengaging fasteners 106A-106D.

In some non-limiting embodiments or aspects, each of the plurality of straps (e.g., lattice strap 101, longitudinal strap 102A, 102B, and lateral straps 103A, 103B) of mattress strap 100 may be visually distinguishable from one another to facilitate the user in assembling mattress strap 100. In some non-limiting embodiments or aspects, each of the plurality of straps of mattress strap 100 may be visually distinguishable from one another through color coding. For example, lattice strap 101 may include a material having a first color, longitudinal straps 102A and 102B may include a material having a second color, and lateral straps 103A and 103B may include a material having a third color. It is contemplated that any number of colors may be used to color code the plurality of straps, and the specific colors and combinations may vary without departing from the scope of the embodiments.

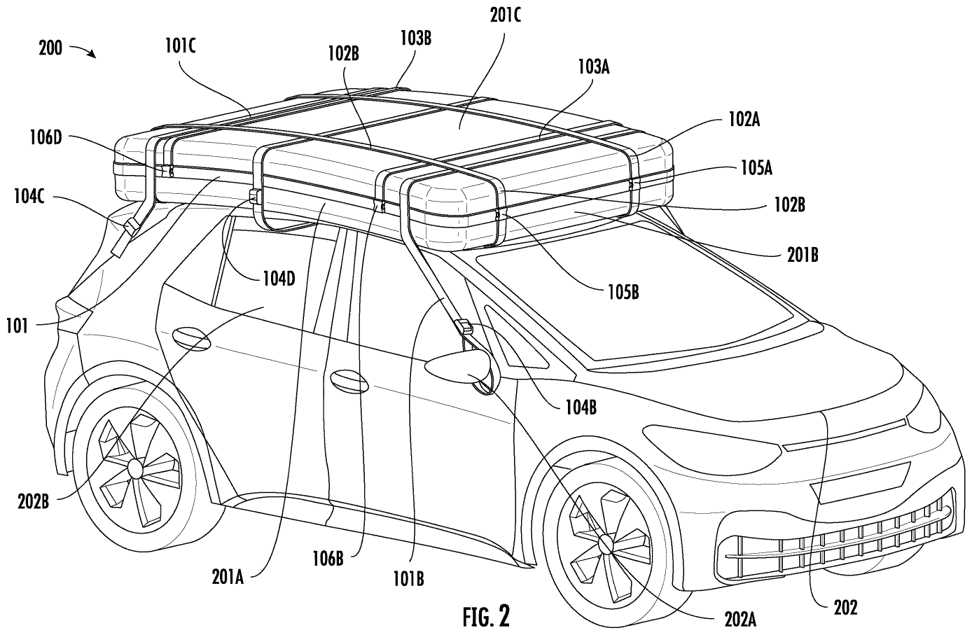

Referring now to FIGS. 2 and 5, a perspective view of a mattress strap and mattress assembly 200 according to some non-limiting embodiments or aspects is shown. As shown in FIG. 2, a single mattress 201 is secured to a top of a motor vehicle 202 via mattress strap 100. A single mattress may be secured to the motor vehicle with lattice strap 101, longitudinal straps 102A and 102B, and lateral straps 103A and 103B. Lattice strap 101 is shown extending around a right side portion 201A and a front side portion 201B of mattress 201, and over a top portion 201C of mattress 201. Lattice strap 101 is secured to a side view mirror 202A of motor vehicle 202 via strap loop 101B. As shown in FIG. 5, strap loops 101A (not shown) and 101B may be fed through a front window or door instead of being secured to side view mirror 202A. Lattice strap 101 is secured to the rear of the vehicle via strap loop 101C. A portion of lattice strap 101 extends under mattress 201 and through a side rear window 202B of motor vehicle 202, further securing lattice strap 101 and mattress 201 to the top of motor vehicle 202. Longitudinal straps 102A and 102B are shown extending around top 201C, bottom, and front 201B portions of mattress 201. Lateral straps 103A and 103B are shown extending around top 201C and right side 201A portions of mattress 201 and attached to lattice strap 101. The one or more fasteners 104A-104D of lattice strap 101 may be tightened by a user as needed to properly secure mattress 201 to the motor vehicle 202. Similarly, fasteners 105A-105D of longitudinal straps 102A and 102B and fasteners 106A-106D of lateral straps 103A and 103B may be tightened by a user as needed to properly secure mattress 201 to the motor vehicle 202.

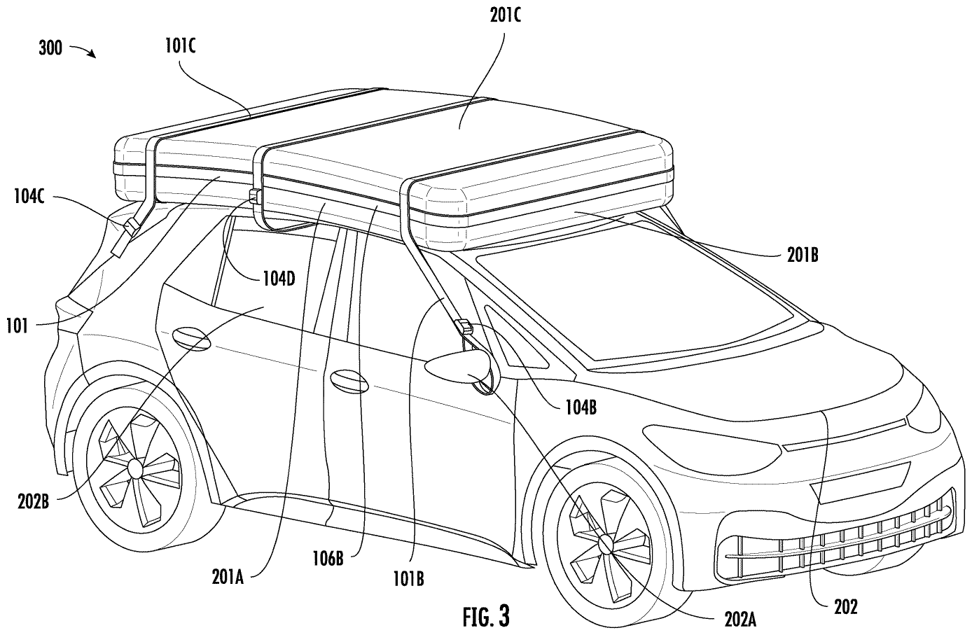

Referring now to FIG. 3, a perspective view of a mattress strap 100 and mattress assembly 300 according to some non-limiting embodiments or aspects is shown. As shown in FIG. 3, a single mattress 201 is secured to a top of motor vehicle 202 via mattress strap 100. A single mattress may be secured to the motor vehicle only with lattice strap 101. Lattice strap 101 is shown extending around a right side portion 201A and a front side portion 201B of mattress 201, and over a top portion 201C of mattress 201. Lattice strap 101 is secured to a side view mirror 202A of motor vehicle 202 via strap loop 101B. Additionally, or alternatively, strap loop 101A may be fed through a front or rear window instead of being secured to side view mirror 202A. Lattice strap 101 is secured to the rear of the vehicle via strap loop 101C. A portion of lattice strap 101 extends under mattress 201 and through a side rear window 202B of motor vehicle 202, further securing lattice strap 101 and mattress 201 to the top of motor vehicle 202. The one or more fasteners 104A-104D of lattice strap 101 may be tightened by a user as needed to properly secure mattress 201 to the motor vehicle 202.

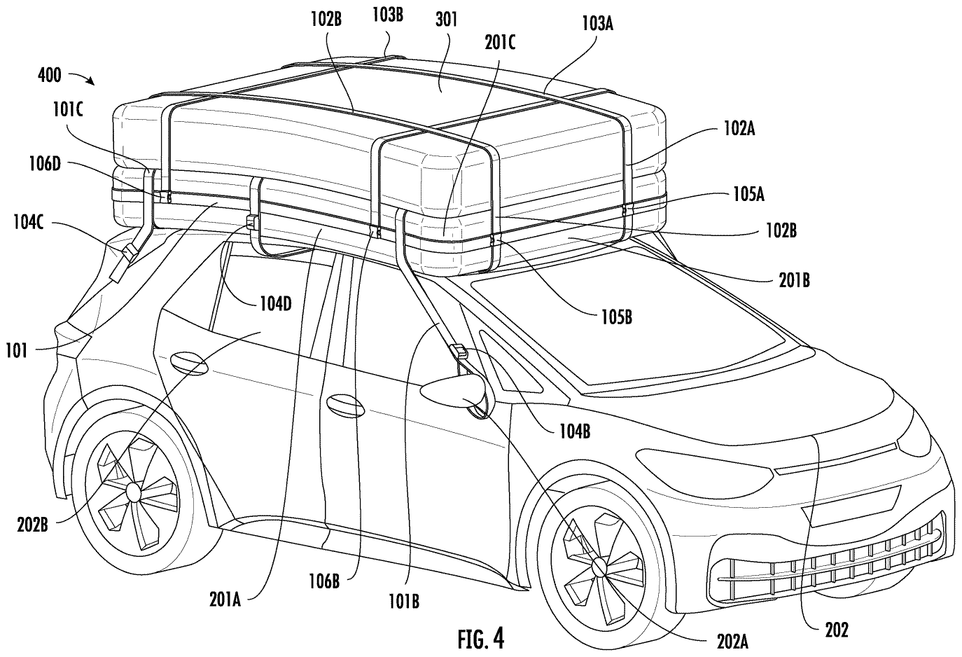

Referring now to FIG. 4, a perspective view of a mattress strap and mattress assembly 400 according to some non-limiting embodiments or aspects is shown. As shown in FIG. 4, mattress strap 100 may accommodate multiple mattresses and/or box springs to the top of motor vehicle 202. For example, a user may secure more than one mattress and/or box spring on top of motor vehicle 202. In some non-limiting embodiments or aspects, the first mattress may be secured to the top of motor vehicle 202 with lattice strap 101, as shown for example in FIG. 3, and may thereafter place a second mattress 301 on top of first mattress 201. In some non-limiting embodiments or aspects, second mattress 301 may then be secured using longitudinal straps 102A and 102B and lateral straps 103A and 103B. For example, the user may loosen fasteners 106A-106D of lateral straps 103A and 103B and loosen fasteners 105A-105D of longitudinal straps 102A and 102B such that second mattress 301 may be positioned between first mattress 201 and each of lateral straps 103A and 103B and longitudinal straps 102A and 102B. In some non-limiting embodiments or aspects, if longitudinal straps 102A and 102B and lateral straps 103A and 103B are not already attached to lattice strap 101, the user may first attach longitudinal straps 102A and 102B and lateral straps 103A and 103B to lattice strap 101, for example via fasteners 105A-105D, 106A-106D, while maintaining longitudinal straps 102A and 102B and lateral straps 103A and 103B in a loosened condition sufficient to permit second mattress 301 to be positioned thereunder. Thereafter, the user may tighten fasteners 105A-105D and 106A-106D such that longitudinal straps 102A and 102B and lateral straps 103A and 103B extend about second mattress 301 and cooperate with lattice strap 101 to retain both first mattress 201 and second mattress 301 in a secured arrangement relative to motor vehicle 202. In this manner, mattress strap 100 may accommodate different configurations, including a single mattress, multiple mattresses, one or more box springs, or combinations thereof.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A mattress securing system for use with a motor vehicle, comprising:
a plurality of straps configured to secure a mattress to a roof of the motor vehicle, the plurality of straps comprising:
a lattice strap;
at least one longitudinal strap; and
at least one lateral strap;
one or more adjustable fasteners connected to each strap of the plurality of straps, the adjustable fasteners configured to allow a user to tighten each strap of the plurality of straps; and
at least one attachment feature configured to secure the plurality of straps to one or more structural components of the motor vehicle.

2. The mattress securing system of claim 1, wherein the lattice strap is configured to extend around at least a portion of a top side of the mattress and at least a portion of a bottom side of the mattress.

3. The mattress securing system of claim 2, wherein the lattice strap is further configured to extend around at least a portion of a front side of the mattress and at least a portion of a rear side of the mattress.

4. The mattress securing system of claim 2, wherein the lattice strap is further configured to extend around at least a portion of a first lateral side of the mattress and at least a portion of a second lateral side of the mattress.

5. The mattress securing system of claim 1, wherein the lattice strap defines a generally rectangular perimeter sized and shaped to receive the mattress therein.

6. The mattress securing system of claim 5, wherein the lattice strap is adjustable to accommodate mattresses of different sizes.

7. The mattress securing system of claim 1, wherein the at least one longitudinal strap is configured to extend along a longitudinal direction of the mattress to inhibit forward and rearward movement of the mattress relative to the motor vehicle.

8. The mattress securing system of claim 7, wherein the at least one longitudinal strap is configured to extend over a top side of the mattress, around a front side of the mattress, around a rear side of the mattress, and beneath a bottom side of the mattress.

9. The mattress securing system of claim 1, wherein the at least one lateral strap is configured to extend along a lateral direction of the mattress to inhibit side-to-side movement of the mattress relative to the motor vehicle.

10. The mattress securing system of claim 9, wherein the at least one lateral strap is configured to extend over a top side of the mattress, around at least a portion of a first lateral side of the mattress, and around at least a portion of a second lateral side of the mattress.

11. The mattress securing system of claim 1, wherein the at least one longitudinal strap and the at least one lateral strap are removably attachable to the lattice strap via the one or more adjustable fasteners.

12. The mattress securing system of claim 1, wherein the at least one attachment feature comprises one or more strap loops configured to engage one or more of a side-view mirror, a window opening, a trunk opening, or a hatch opening of the motor vehicle.

13. The mattress securing system of claim 12, wherein at least one strap loop is configured to be received through an open window of the motor vehicle and retained by closing the window on the at least one strap loop.

14. The mattress securing system of claim 12, wherein at least one strap loop is configured to be positioned within a trunk opening or hatch opening and retained by closing a trunk lid or hatch door on the at least one strap loop.

15. The mattress securing system of claim 1, wherein each strap of the plurality of straps comprises a fabric material.

16. The mattress securing system of claim 15, wherein the fabric material comprises nylon webbing, polyester webbing, polypropylene webbing, or a combination thereof.

17. The mattress securing system of claim 1, wherein the plurality of straps are configured to secure a plurality of mattresses stacked relative to one another on the roof of the motor vehicle.

18. The mattress securing system of claim 17, wherein the lattice strap is configured to secure a first mattress relative to the roof of the motor vehicle, and the at least one longitudinal strap and the at least one lateral strap are configured to secure a second mattress positioned over the first mattress.

19. A mattress securing system for use with a motor vehicle, comprising:
a lattice strap defining a generally rectangular receiving structure sized to receive a mattress therein, the lattice strap configured to extend over a top portion of the mattress and around front, rear, bottom, and lateral side portions of the mattress;
a pair of longitudinal straps removably attachable to the lattice strap and configured to extend over the top portion of the mattress, around the front and rear portions of the mattress, and beneath the bottom portion of the mattress;
a pair of lateral straps removably attachable to the lattice strap and configured to extend over the top portion of the mattress and around opposing lateral side portions of the mattress;
a plurality of adjustable fasteners coupled to the lattice strap, the pair of longitudinal straps, and the pair of lateral straps, the adjustable fasteners configured to permit selective tightening or loosening thereof by a user; and
a plurality of attachment features coupled to the lattice strap and configured to engage one or more structural components of the motor vehicle to secure the mattress on a roof of the motor vehicle.

20. A method of securing a mattress to a motor vehicle, comprising:
positioning a mattress on a roof of the motor vehicle;
placing a lattice strap over the mattress such that the mattress is received within the lattice strap;
securing the lattice strap to one or more structural components of the motor vehicle via one or more attachment features of the lattice strap;
positioning at least one longitudinal strap and at least one lateral strap relative to the mattress such that the at least one longitudinal strap and the at least one lateral strap extend about at least a portion of the mattress; and
tightening one or more adjustable fasteners associated with the lattice strap, the at least one longitudinal strap, and the at least one lateral strap to secure the mattress relative to the motor vehicle.
